(19) United States
(12) Patent Application Publication
(10) Pub. No.: US 2005/0224528 A1
(43) Pub. Date: Oct. 13, 2005

(54) Reclosable pouring element

(76) Inventors: Jorg Berger, Julich (DE); Matthias Dammers, Alsdorf (DE); Heinz Jansen, Hellenthal (DE); Franz-Willi Spelten, Wegberg (DE)

Correspondence Address: THE WEBB LAW FIRM, P.C., 700 KOPPERS BUILDING, 436 SEVENTH AVENUE, PITTSBURGH, PA, 15219, US

(21) Appl. No.: 10/508,505

(22) PCT Filed: Dec. 31, 2002
(86) PCT No.: PCT/EP02/14810

§ 371 Date: May 18, 2005

(30) Foreign Application Priority Data
Mar. 22, 2002 (DE) 102 13 030.2

(51) Int. Cl. B67D 3/00

(52) U.S. Cl. 222/556

(57) ABSTRACT

A reclosable pouring element for opening and reclosing packages, especially rectangular multi-layer composite packages, with a base body having a circumferential flange and a lid joined flexibly thereto, as well as a method for its manufacture and a package provided with such a pouring element are presented and described. In order to retain the good barrier properties of a package provided with a pouring element even with a low overall height of the pouring element before the package is opened for the first time, it is provided that in the region of its pouring opening the base body has a plate whose contour substantially corresponds to the contour of the pouring opening. The lid is connected securely to the plate so that the lid at the same time serves as an opening element.

The invention relates to a reclosable pouring element for opening and reclosing packages, especially rectangular multi-layer composite packages, with a base body having a circumferential flange and a lid joined flexibly thereto, as well as a method for its manufacture and a package provided with such a pouring element.

Drinks packages constructed as multi-layer composite packages are known in a plurality of embodiments, for example, as flat-top composite packages. They are mainly used in the field of liquid packaging in connection with cold, cold-sterile, hot and aseptic filling.

In order to improve the handling of such composite packages and especially to make them reclosable, there is an increasing tendency to provide the composite packages with reclosable pouring elements. These pouring elements can be carried out in one or several pieces and generally have an opening element as well as a lid. Today, such packages are almost exclusively available on the market with reclosable pouring elements.

EP 0 580 593 B1 for example, discloses a multi-layer composite package provided with a pouring element which serves to open the package for the first time and is equipped with a suitable closure element so that it is reclosable. In the region of the cardboard layer and the outer polyethylene layer of the composite material of the package there is provided an indentation to weaken the gable material in which an opening element joined in one piece to the pouring element is pressed into the package material to open the package. Packages provided with pouring elements having screw closures are also known.

Some pouring elements have a pull tab located inside the base body above the pouring opening and sealed on securely there, which must be removed to open the package for the first time by pulling away from the base body (EP 0 750 564 B1). In this case, however, the internal polyethylene layer is frequently only unsatisfactorily removed and the torn-off pull tab also constitutes a waste product to be disposed of separately.

A problem with the pouring elements described previously is that in order to achieve reliable opening of the entire pouring opening, the multi-layer composite package must be sufficiently weakened. Pouring elements stuck onto the package are arranged above a zone of weakening generally formed by perforating the outer layers of the multi-layer composite material; this certainly results in barrier behaviour of the composite material which persists until the actual opening, but requires a certain minimum size (overall height) of the pouring element since, during the opening process, an opening element of the pouring element must destroy the remaining layers. However, if the pouring element is arranged above a pouring opening in the multi-layer composite material sealed over merely with a thin polyethylene layer, the opening process is facilitated even with a small overall height but such a package does not have adequate barrier properties against loss of aroma or adverse influence by light or oxygen.

The object of the invention is thus to configure and further develop the pouring element specified initially and described in detail previously so that the good barrier properties of the package provided therewith are retained until the package is opened for the first time even with a small overall height of the pouring element. It is further desired that such a pouring element should manage without a separate disposable section.

This object is achieved by the base body having a plate in the region of its pouring opening, whose contour substantially corresponds to the contour of the pouring opening which is arranged separated from the flange by at least one slit and whose underside runs flush with the underside of the flange, by the lid being securely connected to the plate so that the lid at the same time serves as an opening element, and by both the base body and the plate having a barrier layer extending parallel to the plane of the flange and covering the slit.

According to the invention, during injection moulding of the pouring element as part of the base body, the plate is separated from this by a thin slit. The plate and lid are then brought together to form a secure joint, for example are stuck flat or welded ultrasonically at several points. Since both the flange of the base body and the plate are provided with a barrier layer, the package provided with such a pouring element according to the invention retains its good barrier properties. In the region of the pouring opening, the weakened properties of the package are to some extent “repaired” by the pouring element applied there and provided with a barrier layer.

In order to open this pouring element according to the invention for the first time, the lid is raised from the base body and the plate with the film located below it, which seals the pouring opening of the package until it is opened for the first time, is removed following the contour precisely as a result of the flat join. In this way not only is a defined pouring opening created but the opening also functions reliably without any disposable part to be disposed of separately being formed. It is also ensured that that the lid with the torn-out connecting piece can be reliably re-closed.

A secure joint is formed between the plate and the lid since both parts are welded, preferably ultrasonically welded.

A further teaching of the invention provides that the base body has a circumferential cross-piece extending substantially perpendicular to the flange, which receives the lid in a sealing fashion in the closed state, wherein it is especially appropriate if the lid can be locked into place with the base body. The locking can be accomplished audibly here in order to indicate to the user that the package thus re-closed is tightly closed, so that it can be shaken for example.

In a further advantageous embodiment of the invention a hinge is provided for the flexible connection of the base body and lid, which can be arranged either on the base body or alternatively on the lid. An especially low overall height is achieved by using a film hinge.

According to a further embodiment of the invention, the barrier layer of the film used consists, for example, of an ethylene vinyl alcohol (EVOH), polyethylene (PE), polyamide or of aluminium foil or of a mixture of said materials.

According to a further teaching of the invention, the base body and/or the lid can have an originality seal which indicates to the user if a package has been opened without authorisation before the use for which it is intended. For this purpose, for example, the base body and lid can be constructed with a connecting cross-piece constructed as a predetermined breaking point.

Finally, according to a further advantageous embodiment of the invention, the base body and the lid can be manufactured in one piece. In this case, both parts are manufactured in a single injection process and the burr connecting them is removed before joining the plate and the lid.

According to a first method of manufacture according to the invention, the base body of the pouring element is activated by means of a heat source and joined to the film by means of a stationary die. In this case, the thermal energy can be supplied between the pouring element and the film or it is alternatively also feasible that the thermal energy is supplied below the film. In this case, the film is penetrated by the energy emitted by the heat source.

After plastifying the seal surfaces, the film and the underside of the base body are joined together without any pockets. Roll goods are preferably used as the film. Separation of the pouring elements can take place directly after joining with the film by punching out or however, just before the actual application of the pouring element in the filling machine. A substantial advantage of said last-mentioned possibility is that a partly extremely complex sorting process of the pouring elements before supply to the applicator can be completely dispensed with if the pouring elements on the film strips are arranged in fixed positions.

According to an alternative method of manufacture it is provided that the film is a film strip prepared from a roll and the film strip is pulled through the injection moulding die for the pouring element so that the pouring element is injected onto the film without any pockets. In this case, the flange of the base body and the plate located therein are joined to the barrier film. In this method of manufacture the pouring element can also be punched out in the vicinity of the injection moulding die in order to be further processed as loose bulk goods or however, to remain until application on the film strip.

The invention is explained in detail subsequently with reference to the drawings which merely show preferred embodiments wherein:

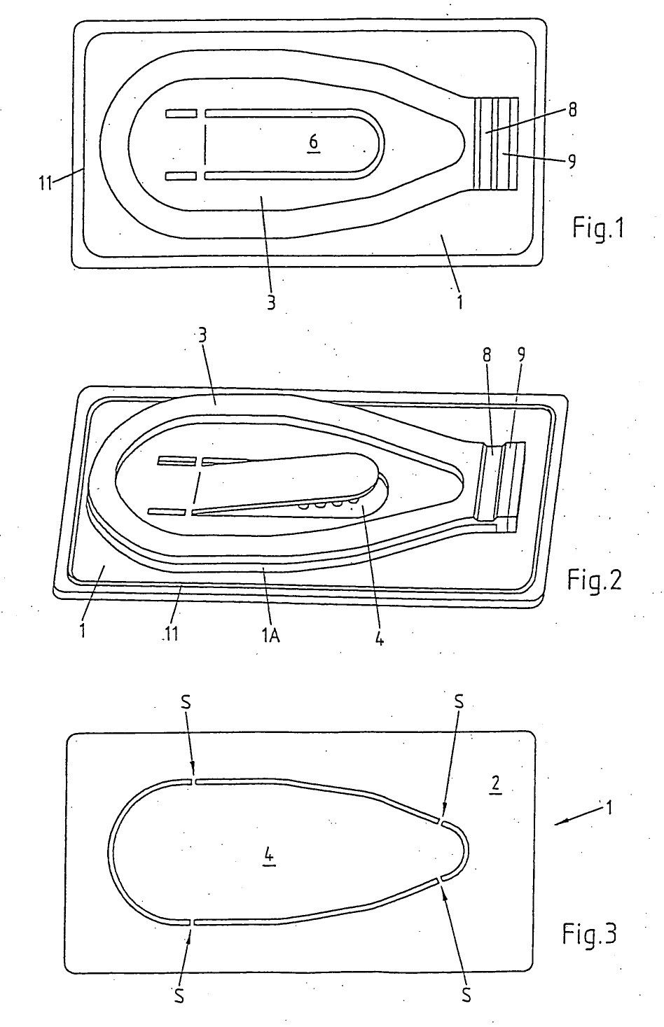

FIG. 1 is a top view of an embodiment of a pouring element according to the invention in the closed state,

FIG. 2 is a perspective view of the pouring element from FIG. 1,

FIG. 3 is a view of the pouring element from FIG. 1 from below,

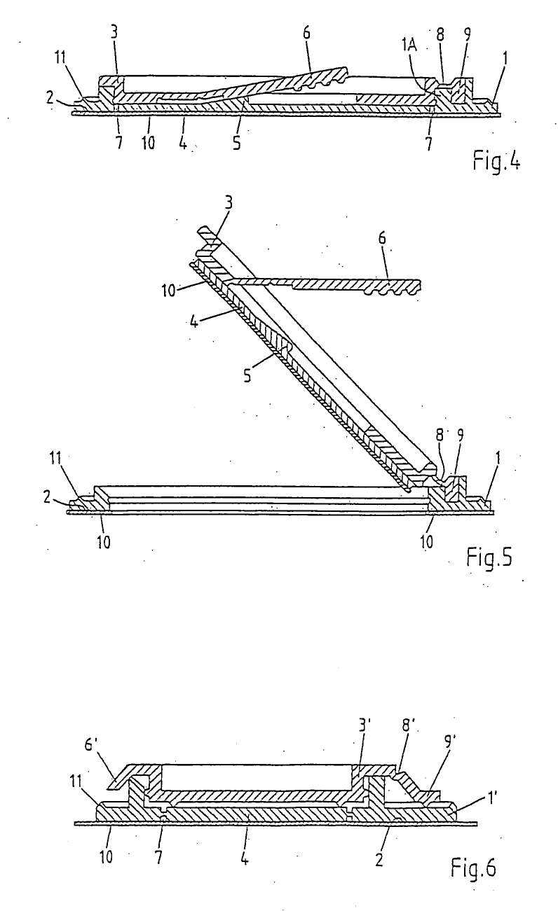

FIG. 4 is a longitudinal section of the pouring element from FIG. 1,

FIG. 5 is a longitudinal section of the pouring element from FIG. 4 but in the opened state,

FIG. 6 is a cross-section of a second embodiment of a pouring element according to the invention,

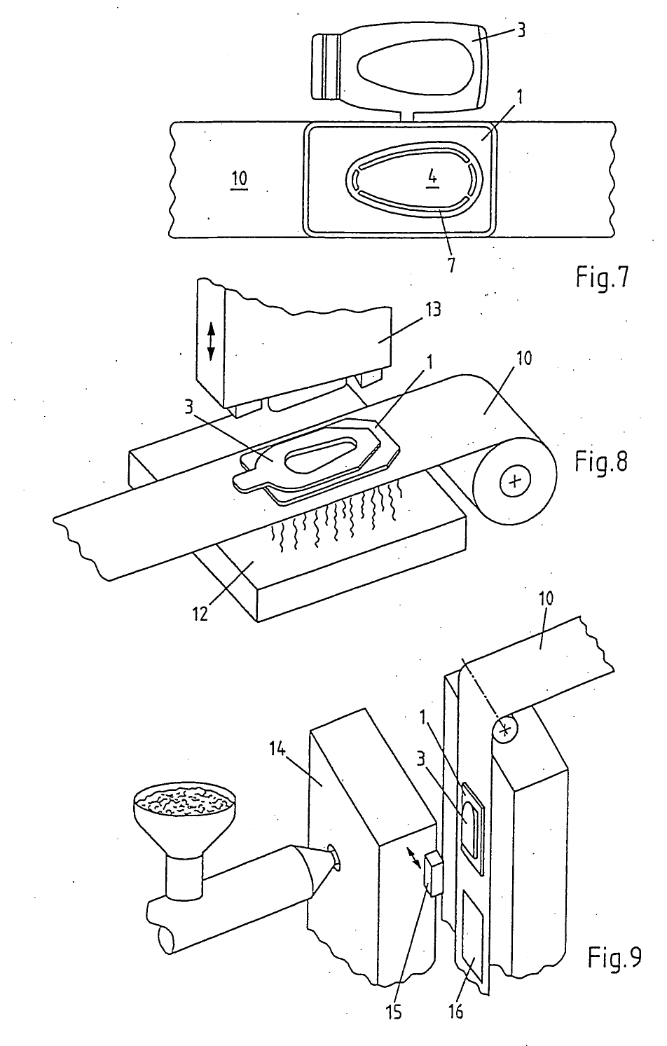

FIG. 7 is a schematic top view of another pouring element according to the invention with a base body applied to a film,

FIG. 8 is a perspective view of a further pouring element according to the invention applied to a film, and

FIG. 9 is a perspective view of a further pouring element according to the invention injected onto a film.

FIGS. 1 to 3 show a pouring element according to the invention without a barrier layer for better explanation. The pouring element has a base body 1 with a circumferential flange 2 and a lid 3 joined flexibly to the base body 1. As can be seen from the view from below in FIG. 3 in particular, inside the base body 1 there is provided a plate 4 whose size corresponds to the later pouring opening, which is connected to the circumferential flange 2 of the base body by four cross-pieces S in the embodiment shown and insofar preferred. In order to facilitate the opening process, the plate 4 has a wedge-shaped elevation 5, as can be seen from FIG. 4, in order to fasten a grip tab 6, which has a corrugation, not described in greater detail, provided on the underside of its free end, at a slight angle to the lid 3.

As can be seen from FIG. 3, the plate 4 is surrounded by a slit 7 which is only interrupted in the region of the cross-piece S. Since the plate 4 is securely joined to the lid 3, opening the lid 3 with the aid of the grip tab 6 results in breaking of the cross-pieces S and release of the plate 4 from the base body 1.

In order that the lid 3 is not completely removed from the base body 1 during the opening process, the right-hand part of the lid 3 in the drawing is joined securely to the base body 1 by means of a connecting element 9. Between the connecting element 9 and the actual lid 3 there is arranged a hinge 8 which is preferably constructed as a film hinge.

FIGS. 4 and 5 show a longitudinal section of the pouring element according to the invention, described in detail previously, already joined to a barrier film 10 arranged holohedrally on the underside of the base body 1. It can be seen clearly from FIG. 5 that when the lid 3 of the pouring element according to the invention is opened for the first time by actuating the grip tab 6, the piece of film of the barrier film 10 joined securely thereto under the lid 4 is pulled out from the film composite, following the contour precisely.

FIG. 6 shows an alternative embodiment wherein, before the ultrasonic welding of the lid 3′ with the base body 1′, energy directors between the lid 3′ and the plate 4 and the connecting element 9′ and the base body 1′ ensure a secure join during welding.

It is further deduced from FIG. 1 and FIGS. 4 to 6 that above the circumferential flange 2 there is provided a circumferential energy director 11 so that during application of the pouring element which is pushed from below through an opening in the multi-layer composite package not shown, a sealed unit is achieved.

In principle, FIG. 7 again shows a pouring element manufactured in one piece in which the lid 3 is joined to the base body 1 via a cross-piece not described in detail, which must be removed before bringing the lid 3 and the plate 4 together. Also shown at the same time is a strip of a film 10 wherein the joining of the base body 1, lid 3 and film 10 can be accomplished in a single working step. This is shown in FIG. 8 where the strip-like film 10 is shown as roll goods and the joining of the parts activated by a heat source 12 is made by means of a press die 13.

Finally FIG. 9 shows that it is also possible to pull the strip of barrier film 10 through an opened injection moulding die 14 which is merely shown schematically. A suitable slider 15 inside the injection moulding die 14 ensures that the undercuts of the pouring element are released before opening the mould. Here it is also possible to use the movement for opening and closing the injection moulding die 14 simultaneously to punch out the pouring element injected onto the barrier film 10, as should be indicated by the punched-out surface 16.

1-21. (canceled)

22. A reclosable pouring element for opening and reclosing packages comprising a base body having a circumferential flange joined flexibly to a lid;
wherein, the base body, in a region of a pouring opening, further includes a plate whose contour substantially corresponds to the contour of the pouring opening, arranged away from the flange by at least one slit and whose underside runs flush with an underside of the flange; wherein the lid is connected securely to the plate allowing the lid to serve as an opening element; and wherein, both the base body and the plate have a film with a barrier layer, the barrier layer extending parallel to a plane of the flange and covering the slit.

23. The pouring element according to claim 22, wherein the plate is welded to the lid.

24. The pouring element according to claim 23, wherein the based body has a cross-piece running around the pouring opening extending substantially perpendicular to the flange, wherein the cross-piece receives the lid in a sealing fashion in a closed state.

25. The pouring element according to claim 24, wherein the lid can be locked into place with the base body.

26. The pouring element according to claim 22, wherein a hinge provides a flexible connection between the base body and the lid and the hinge is arranged in the lid.

27. The pouring element according to claim 22, wherein a hinge provides a flexible connection between the base body and the lid and the hinge is arranged on the base body.

28. The pouring element according to claim 26, wherein the hinge is constructed as a film hinge.

29. The pouring element according to claim 22, wherein the barrier layer of the film consists of an ethylene vinyl alcohol (EVOH).

30. The pouring element according to claim 22, wherein the barrier layer is an aluminium foil.

31. The pouring element according to claim 22, wherein the barrier layer is a polyethylene (PE) film.

32. The pouring element according to claim 22, wherein the barrier layer of the film consists of polyamide (PA).

33. The pouring element according to claim 22, wherein the barrier layer of the film comprises a mixture of an ethylene vinyl alcohol (EVOH), aluminium foil, polyethylene (PE) film, and polyamide (PA).

34. The pouring element according to claim 29, wherein the film provided for the barrier layer is used as roll goods.

35. The pouring element according to claim 22, wherein at least one of the base body and the lid have an originality seal.

36. The pouring element according to claim 22, wherein the base body and the lid are manufactured as one piece.

37. A method for manufacture of a pouring element for opening and reclosing packages comprising the steps of:
activating the base body of the pouring element by means of a heat source; and
joining the base body to the film by means of a stationary die.

38. The method according to claim 37, further comprising supplying thermal energy between the pouring element and the film.

39. The method according to claim 37, further comprising supplying thermal energy below the film.

40. The method according to claim 37, wherein the film is a film strip supplied from a roll and the film strip is pulled through an injection moulding die of the pouring element allowing a circumferential flange and a plate of the pouring element to be injected pocket-free onto the film.

41. The method according to claim 37, wherein the pouring elements remain on a film strip of barrier material and are only separated before their application in a filling machine.

42. A package for use with a pouring element for opening and closing the package, wherein the package is a rectangular, multi-layer composite package.

43. The package according to claim 42, wherein the package comprises an opening with a shape substantially corresponding to a shape of a lid of the pouring element, wherein the pouring element and a circumferential flange of the pouring element are attached to an inside surface of the multi-layer composite material.

44. The pouring element according to claim 23, wherein the plate is ultrasonically welded to the lid.

45. The pouring element according to claim 27, wherein the hinge is constructed as a film hinge.
